(19) United States
(12) Patent Application Publication
(10) Pub. No.: US 2008/0061268 A1
(43) Pub. Date: Mar. 13, 2008

(54) Heat transport medium

(75) Inventors: Eiichi Torigoe, Anjo-city (JP); Touru Kawaguchi, Kariya-city (JP); Yoshimasa Hijikata, Nishikamo-gun (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/894,528

(22) Filed: Aug. 21, 2007

(30) Foreign Application Priority Data
Aug. 22, 2006 (JP) 2006-225797

(51) Int. Cl. C09K 5/00

(52) U.S. Cl. 252/73; 252/71

(57) ABSTRACT

A heat transport medium comprises a single solvent and fine particles 1 of a predetermined material dispersed in the solvent, and transports heat transferred from a heat transfer surface 5. The fine particles 1 consist of one or more atoms, and have a structural substances 3 arranged on the surfaces to protect the fine particles 1. The heat transport medium satisfies a relationship among a diameter A, a length B and an average clearance distance C, which is represented by the expressions A≦B, and B≦C/2, wherein the diameter A is the diameter of a solvent molecule 2 composing the solvent, the length B is a length of a structural substance 3 extending from a functional group 3a to be adsorbed on the fine particles 1, and the average clearance distance C is an average distance between the fine particles dispersed in the solvent.

### TECHNICAL FIELD

The present invention relates to a heat transport medium which transfers and transports heat.

### BACKGROUND ART

A heat transport medium, which transfers and transports heat from a heat source externally, has been conventionally used for a device which dissipates heat from a heat source, e.g., an engine, an electric apparatus and the like mounted on a vehicle. The heat transport medium takes heat away from a heat source, and dissipates it from a heat exchanger. Moreover, the heat transport medium is also used to transfer heat to an object to be heated. It has been required for such a heat transport medium to have higher cooling capacity, that is, higher heat transport capacity in order to increase energy efficiency of equipment such as a heat exchanger or the like.

To improve the heat transport capacity of a heat transport medium, for example, a technique has been known in which solid particles of a high heat conductive material, such as a metal are included and dispersed in the medium. By including the particles of a high heat conductive material, a heat transport medium has higher heat conductivity than a medium that does not include the particles. More particularly, it has been known that the heat conductivity of a heat transport medium that includes particles, changes based on the Maxwell formula of 1881, as follows:

Heat conductivity of a medium including spherical particles increases according to the volume fraction of the particles.

Heat conductivity of a medium including spherical particles increases according to the ratio of surface area to the volume of the particles.

However, there was a limitation of improvement of heat conductivity of a medium by this method.

On the other hand, a technique of making fine particles of a micron or nano size has been recently developed for the particles included in the medium. It has been confirmed that heat conductivity of a medium remarkably increases when fine particles are dispersed in the medium.

For example, Applied Physics Letters, Vol. 78, No. 6, pp. 718-720 (2001) states that heat conductivity of a medium largely increases when a medium composed of ethylene glycol includes a small amount of fine particles of copper (Cu) having a diameter of 10 nm (nano meter) or less.

FIG. 5, in Applied Physics Letters, Vol. 78, No. 6, pp. 718-720 (2001), is a graph showing a relationship between a volume content ratio of particles in a medium and a heat conductivity increasing ratio k/k₀ (heat conductivity k of a medium after adding fine particles/heat conductivity k₀ of a medium before adding fine particle), when various particles including copper particles are added to ethylene glycol.

As illustrated in FIG. 5, whenever a medium that includes particles composed of copper oxide (CuO), particles composed of alumina (Al₂O₃), which have a diameter of about 30 nm, and particles composed of copper having a diameter of about 10 nm or less, the heat conductivity increasing ratio of the medium increases linearly according to the increased volume content ratio of the particles. More particularly, in the case of nano particles having a diameter of 10 nm or less, heat conductivity is remarkably improved by adding a fewer amount of particles to the medium. Further, when an acid is added to Cu particles, particles are dispersed more stably in a medium, and thus a higher heat conductivity can be obtained. In addition, in FIG. 5, Cu (old) represents copper particles prepared two months before measurement, Cu (fresh) represents copper particles prepared two days before measurement, and Cu+Acid represents copper particles which have been stabilized as metal particles by adding an acid.

Like Applied Physics Letters, Vol. 78, No. 6, pp. 718-720 (2001), for example, Japanese Unexamined Patent Publication (Kokai) Nos. 2004-85108, 2004-501269 and 2004-339461 states that heat conductivity and heat diffusivity of a medium increase when fine particles having high heat conductivity are dispersed in a medium. More particularly, Japanese Unexamined Patent Publication (Kokai) No. 2004-501269 teaches that a salt of carboxylic acid is adsorbed on the surface of fine metal particles so as to stabilize a colloidal solution of fine particles, and thus heat transport is smoothly carried out between the fine particles and medium. In addition, when a medium includes particles, it is desirable that the particles be dispersed more stably in the medium.

Japanese Unexamined Patent Publication (Kohyo) Nos. 2002-532243 and No. 2002-532242 describe a technique to stably disperse particles in a medium, which is not a heat transport medium. For example, in a case of an ink jet printer, these patent documents propose a polymer having a hydrophilic group and the hydrophobic group being used as a dispersant when hydrophobic particles are dispersed in a medium such as water, or the like. In the techniques described in Japanese Unexamined Patent Publication (Kohyo) Nos. 2002-532243 and No. 2002-532242, particles can be dispersed more stably in a medium by using a solvate obtained by compatibilizing a solvent to particle surfaces.

The above-described techniques for a heat transport medium increase heat conductivity so as to improve a heat transport capacity of a medium. Heat conductivity is an index expressing how heat is easily transferred inside a material (a medium in this case). Further, when a heat transport medium is used, the heat conductivity, as well as the heat transfer rate which is an index expressing how heat is transferred from a heat transfer surface, which is a heat source, to a medium, or from the medium to the heat transfer surface are also important.

The relationship between the heat transfer rate α and heat conductivity κ in a medium is represented by the following expression (1).
α∝κ^{2/3}·v^{(-1/6)}·ρ^{1/3}·Cₚ^{1/3} (1)

In this expression, v represents the kinematic viscosity of a medium, ρ represents the density of a medium, and Cₚ represents the specific heat of a medium. As can be understood from the expression (1), the heat transfer rate a is proportional to ⅔-power of the heat conductivity κ. Even if it were possible to dramatically improve the heat conductivity of a medium by the conventional technique of dispersing fine particles in a heat transport medium, such an effect of improving the heat transfer rate of the medium is proportional to ⅔-power of the improved heat conductivity, it would be difficult to improve both heat conductivity and heat transfer rate.

### SUMMARY OF INVENTION

Under these circumstances, the present invention has been conceived of, and an object of the present invention is to provide a heat transport medium capable of accurately increasing heat transfer while maintaining high heat conductivity, and realizing heat transport with higher efficiency.

To achieve the above object, the present invention provides a heat transport medium, which transports heat transferred from a heat transfer surface. In the present invention, the heat transport medium comprises a solvent, and fine particles of a predetermined material, in which the fine particles are dispersed in the solvent. Each fine particle consists of one or more atoms, and has a plurality of structural substances arranged on the surface thereof, wherein the structural substances have a functional group to be adsorbed on each fine particle to protect the fine particles. The relationship between a diameter A, a length B and an average clearance distance C is represented by the following expressions
A≦B, and B≦C/2
where diameter A is a diameter of a solvent molecule, length B is a length of a structural substance extending from a functional group to be adsorbed on the fine particle, and the average clearance distance C is an average distance between the fine particles dispersed in the solvent.

According to the heat transport medium including the above-described constitution, the solvent molecule is easily taken into a space between the structural substances arranged on a surface of the fine particle and on a surface of the structural substance. Thus, a structured area can be formed by adsorbing the solvent molecule around each fine particle.

Further, in one preferable constitution of the present invention, when the solvent consists of a single component, the length B of the structural substance is set so as to be equal to or larger than the diameter A of the solvent molecule, but half or less the average clearance distance C. In another preferable constitution of the present invention, when the solvent consists of two or more kinds of components, the length B of the structural substance is set so as to be equal to or larger than the diameter A of a solvent molecule having the maximum diameter among these solvent molecules, but half or less the average clearance distance C. Therefore, the structural substance can be easily vibrated or shaken so as to be easily deformed. Thus, separating the solvent molecules from the surfaces of fine particles and structural substances, in other words, disassembling the structured areas, can be controlled so as to be easily carried out.

When the structured area is formed and disassembled, exothermic and endothermic reactions are generated between the solvent molecule and the fine particle, and between the solvent molecule and the structural substance through these structural changes. Therefore, an amount of heat corresponding to the latent heat is transferred from the heat transfer surface to the heat transport medium, the heat transfer rate of the heat transport medium can be improved, and thus the heat transport capacity of the medium can be increased.

In another preferable constitution of the present invention, the heat conductivity of the fine particle is set so as to be higher than that of the solvent in the constitution described above. In other words, the fine particle having higher heat conductivity than the heat conductivity of the solvent is used. Since the fine particle having higher heat conductivity than that of the solvent is dispersed in the solvent, the heat conductivity of the heat transport medium can be accurately improved.

In a more preferable embodiment of the present invention, a structural substance including a straight-chain organic material regularly arranged on the surface of the fine particle can be employed. In another preferable constitution, a structural substance including a cyclic organic material regularly arranged on the surface of the fine particle can be also used. With either of the above constitutions, the structural substance is regularly arranged on the surface of the fine particles, to promote structuring.

In a more preferable embodiment of the present invention described above, an average diameter of the fine particles is 5 nm or less. Thus, a surface area of the fine particle dispersed in the solvent increase remarkably, so that a larger amount of solvent molecules can form the structured area. Therefore, the thermal transport capacity of the heat transport medium can be improved furthermore.

In a more preferable embodiment of the present invention described above, any one of the following constitutions can be employed, in other words:

a constitution in which the fine particles consist of a metal can be employed;

the constitution in which the fine particles consist of an inorganic material can be employed;

the constitution in which the fine particles consist of an oxide can be employed;

the constitution in which the fine particles consist of an organic material can be employed; or

the constitution in which the fine particles consist of two or more kinds of materials can be employed.

As for the constitution in which the fine particles consist of two or more kinds of materials, it is especially effective that fine particles consisting of two or more kinds of materials have a layered structure, and the material in an inner layer has higher heat conductivity than that of an outer layer.

Further, whenever any materials or structures are used as the fine particles, a heat transport medium can have high heat transport capacity. More particularly, when fine particles formed in a layered structure of a plurality of materials has higher heat conductivity on the inner layer side, heat transfer can be easily carried out from a heat transfer surface not only on the surfaces of fine particles, but also on the insides of fine particles.

On the other hand, in another preferable embodiment of the present invention, any one of the following constitutions can be used: a constitution in which fine particles include a metal which is gold, a solvent which is water, and the structural substance having a hydrophilic group; a constitution in which the metal composing the fine particle is gold, the solvent is toluene, and the structural substance has a hydrophobic group, can be used. According to one constitution described above, for example, mercapt succinic acid can be used as a structural substance. According to another constitution described above, n-octadecanethiol can be used as a structural substance.

Also, in a more preferable embodiment of the present invention described above, if the heat transport medium contains one or more kinds of freezing-point depressants, it is effective to use the heat transport medium as antifreeze liquid.

As for the freezing-point depressants, in one preferable constitution of the present invention, a solid freezing-point depressant such as potassium acetate or the like can be used, and in another preferable constitution of the present invention, a liquid freezing-point depressant such as ethylene glycol or the like can be used. If a heat transport medium has either of these constitutions, the heat transport medium can be easily used in a cold environment due to the low freezing point thereof.

In another preferable constitution of the present invention, the heat transport medium in any of the about constitutions may contain at least any one of a rust preventing agent and an anti-oxidant as an additive.

### BRIEF DESCRIPTION OF THE DRAWINGS

FIG. 1(a) is a view schematically illustrating the structured state of the first embodiment of a heat transport medium.

FIG. 1(b) is a view schematically illustrating the disassembled state, in the first embodiment of the present invention.

FIG. 2 is an enlarged view of FIG. 1(a).

FIG. 3(a) to FIG. 3(d) are views schematically illustrating the other constitutional examples of the structural substances as modified examples of the heat transport medium of the first embodiment.

FIG. 4 is a perspective view schematically illustrating the schematic constitution of fine particles as modified examples of the heat transport medium of the first embodiment.

FIG. 5 is a graph illustrating the relationship between a volume content of fine particles and a heat conductivity ratio of a heat transport medium in an example of a conventional heat transport medium.

### DETAILED DESCRIPTION

A heat transport medium comprises a solvent and fine particles. The heat transport medium can include additional functions, e.g., depression of a solidifying point or a freezing point, rust preventing, and the like.

A solvent is an aggregate of a solvent molecule, and includes at least a component capable of having two states, that in other words is, a structured state in which a solvent molecule is systematically structured and a disassembled state in which the structured state is disassembled. In addition, changes between the structured state and the disassembled state are reversible, and the changes can be caused by a physically external trigger, such as a temperature or the like. When the structured state changes to the disassembled state, a heat transport medium absorbs heat. When the disassembled state changes to the structured state, a heat transport medium dissipates heat. Therefore, the combination of the component of a solvent and the component of fine particles is selected so as to form the structured state and the disassembled state around the fine particles. The component of a liquid, the component of fine particles, and an external trigger are selected according to the application of a heat transport medium.

In a typical embodiment, a solvent is a carrier for dispersing fine particles. The solvent can disperse fine particles and can be used as a fluid for transporting fine particles. The fluid can be provided in a liquid state or a vapor state, and may be composed of a single component or a plurality of components. For example, water can be used as the fluid. For example, a liquid high polymer can be used as the fluid. Further, a mixture can be used as the fluid. For example, a mixture of water, ethylene glycol and an other functional component can be used.

### EXAMPLES

### First Embodiment

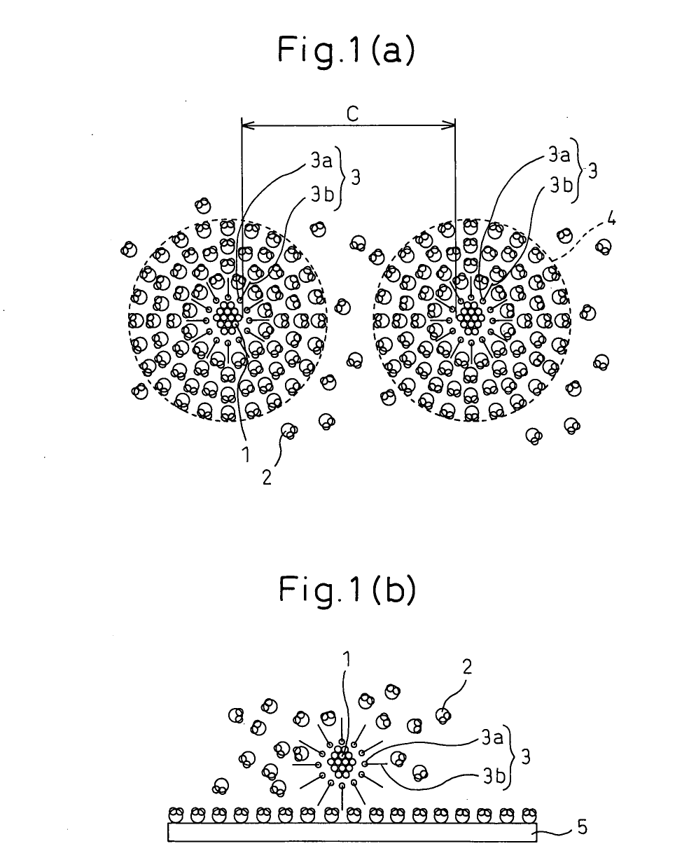

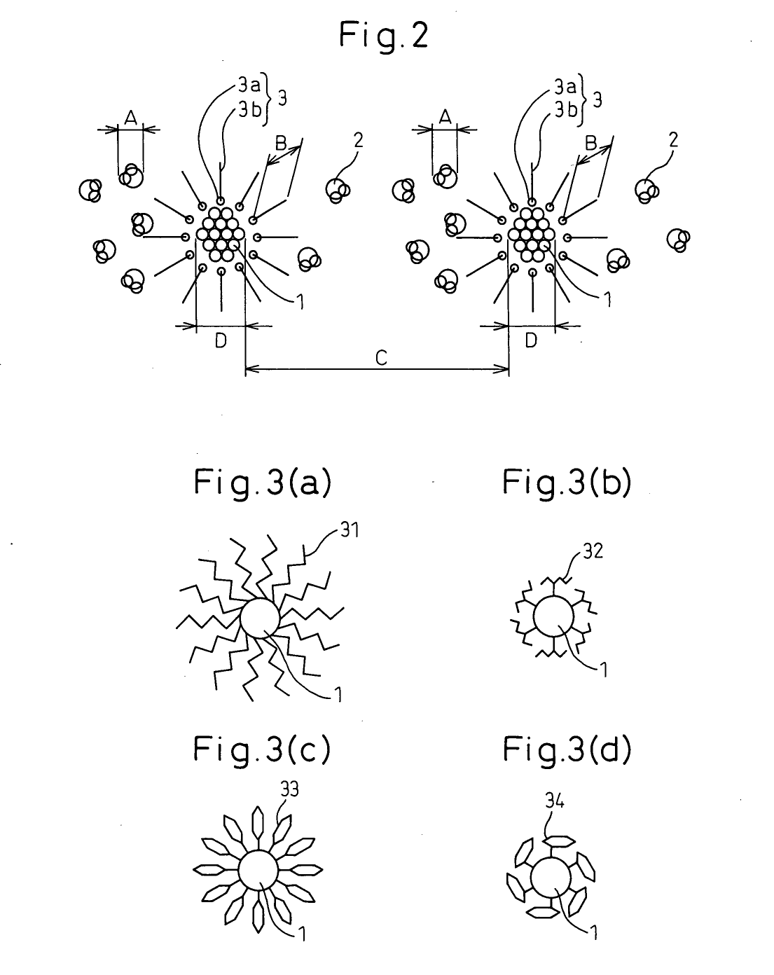

The First Embodiment of a heat transport medium according to the present invention will be described in detail below with reference to FIGS. 1(a), 1(b) and 2.

For example, a heat transport medium according to this Embodiment is used to cool an engine, exhaust gas emissions or the like mounted on a vehicle. The heat transport medium transfers and transports heat from a heat source externally. For example, a solvent used in the heat transport medium comprises a single component, such as water or the like, and fine particles having higher heat conductivity than that of the solvent.

The heat transport medium of this Embodiment transfers heat, having two different states, one of which is a structured state where a solvent is formed surrounded by fine particles, and another is a disassembled state where the structured state is disassembled. FIGS. 1(a) and 1(b) schematically illustrate the above-described two states in the heat transport medium.

In the structured state, a plurality of fine particles 1 are surrounded by a solvent molecule 2 of water, and dispersed as illustrated in FIG. 1(a). For example, the fine particles 1 can be selected from particles consisting of a metal, such as gold (Au), silver (Ag), copper (Cu), iron (Fe), nickel (Ni) or the like, or an inorganic material such as silicon (Si), fluorine (F) or the like, particles consisting of an oxide, such as alumina (Al₂O₃), magnesium oxide (MgO), copper oxide (CuO), diiron trioxide (Fe₂O₃), titanium oxide (TiO) or the like, or polymer particles consisting of a resin or the like.

Structural substances 3 to protect fine particles 1 are regularly arranged on a surface of the fine particles 1 dispersed in the heat transport medium so as to form a protection film. The structural substance 3 includes a functional group 3a to be adsorbed into the surface of the fine particle 1, and a functional group 3b having a shape extending from the functional group 3a and having high affinity to the solvent molecule 2. Further, the functional group 3b includes an organic material having a linear chain as a main chain.

For example, when gold is used as the fine particle 1, a thiol group (SH group) can be used as the functional group 3a adsorbed on the fine particle 1. As the functional group 3b having high affinity to the solvent molecule 2 consisting of water, for example, a hydrophilic group, such as a carboxylic group (COOH group), an amino group (NH₂ group), a hydroxyl group (OH group), or a sulfo group (SO₃H group) can be used.

More particularly, mercaptosuccinic acid (C₄H₆O₄S) can be used as the structural substance 3, which includes a thiol group as the functional group 3a and a hydroxyl group as the functional group 3b. When the structural substances 3 are arranged on the surface of the fine particle 1, the solvent molecules 2 are taken into the spaces between the structural substances 3 and taken onto the surfaces of the structural substances 3 so as to form structured areas 4 where solvent molecules 2 are aggregated around the fine particles 1. Then, each fine particle 1 is stably dispersed in the heat transport medium (adsorption of a solvent molecule to fine particles).

On the other hand, the structured state changes to the disassembled state as illustrated in FIG. 1(b) due to various factors such as mutual clashing of the fine particles 1, clashing of the fine particles 1 to the wall surface of a heat exchanger or the like where a heat transport medium flows, vibrating or shaking of the structural substance 3 attendant on temperature varying of a heat transport medium, and the like. In the disassembled state, the solvent molecules 2 are separated from the spaces between the structural substances 3 or the surfaces of the structural substances 3, and exist irregularly in the solvent. Further, a part of the separated solvent molecules 2 are adsorbed on heat transfer surfaces 5 to which heat is transferred from a heat transport medium (separation of solvent molecules from fine particles).

The two different states illustrated in FIGS. 1(a) and 1(b) change reversibly with absorption of heat externally to the solvent, and dissipation of heat from the solvent externally. The change from the structured state to the disassembled state is an endothermic reaction, but the change from the disassembled state to the structured state is an exothermic reaction. Thus, when these states change, latent heat is generated. The latent heat represents energy differences between two states at a fixed temperature. For example, in the case of water, latent heat generated due to the structural change from solid (ice) to liquid (water) is about 6,000 J/mol (joule/mol). This value is remarkably larger than 75 J/mol, which is the value of molar specific heat (sensible heat) of water. Further, the inventors have confirmed that latent heat (energy difference) between the structured state and the disassembled state according to this embodiment is also great. Thus, an amount of heat to be transported can greatly increase through these state changes.

Next, FIG. 2 is a simpler enlarged schematic view by FIG. 1(a). The more concrete structure in the structured state will be described in detail by referring to FIG. 2. In this Embodiment, a solvent molecule 2 is water, fine particles 1 are gold, and a structural substances 3 is mercaptosuccinic acid.

As illustrated in FIG. 2, the diameter A of each of the solvent molecules 2 used in the heat transport medium in this Embodiment is about 0.1 nm. For example, when structural substances 3 arranged on the surface of fine particles 1 consist of mercaptosuccinic acid, the length B of the structural substance 3 extending from a functional group 3a to be adsorbed on the fine particle 1 is about 1 nm. In other words, the length B of the structural substance 3 is equal to or larger than the diameter A of the solvent molecule, and the expression of A≦B is satisfied. Further, the length B of the structural substance 3 is half or less than the average clearance distance C between the dispersed fine particles, and the expression of B≦C/2 is satisfied.

If the expression A≦B is satisfied, solvent molecules 2 can be easily moved into the space between the structural substances 3 and onto the surfaces thereof, and thus the solvent molecule 2 is easily adsorbed on the surface of the fine particle 1 so as to form the above-described structured area 4 (refer to FIGS. 1(a) and 1(b)). If the expression of B≦C/2 is satisfied, the structural substance 3 can be easily deformed, in other words, shaken or vibrated, and thus the solvent molecule 2 is easily separated from the surface of the fine particle 1 so as to disassemble the structured area 4.

By constituting a heat transport medium satisfying the expressions of A≦B, and B≦C/2, adsorbing/separating of the solvent molecule to/from the fine particle 1 can be properly controlled, and thus an amount of heat transport can greatly increase. In addition, a heat transport medium with such a constitution can be obtained by adjusting a size of the solvent molecule, the length B of the structural substance 3 included in the heat transport medium, and an amount of the fine particles 1 included in the heat transport medium.

The diameter A of a solvent molecule is measured by specifying a component by a liquid chromatograph mass spectrometer or the like. The length B of a structural substance is measured by specifying a component and structure by a gas chromatograph mass spectrometer, a Fourier transform infrared spectrometer, a nuclear magnetic resonance analyzer, or the like. The average clearance distance C is calculated by specifying the weight ratio of particles measured by a thermogravimetric device, an average particle diameter measured by a transmission electron microscope or a particle-size distribution measuring device, and a component measured by a characteristic X-ray analyzer or an electronic spectrometer.

More particularly, for example, the fine particles 1 are an aggregate of 150 gold (Au) atoms, and an average diameter D of one particle is about 1.8 nm. When fine particles 1 have the average particle diameter of 2 nm or less, where the average particle diameter D is experimentally about 5 nm or less at the maximum, the surface area of fine particles 1 dispersed in a heat transport medium can greatly increase, and thus a greater amount of solvent molecules 2 can form a structured area 4.

As described above, based on a heat transport medium according to this Embodiment, the following advantageous effects can be obtained.

(1) A fine particle 1 comprises about 150 gold (Au) atoms, structural substances 3 to protect the fine particle 1 are arranged on the surface of the fine particle 1, and the length B of the structural substance 3 is equal to or larger than the diameter A of solvent molecules 2. Taking this constitution, the solvent molecules 2 can be easily moved into the spaces between the structural substances 3 arranged on the surface of the fine particle 1, and onto the surfaces of the structural substances 3, so that the solvent molecules 2 are adsorbed around the fine particles so as to form a structured area 4.

The structural substance 3 can be easily deformed by vibration and shaking. Thus, the solvent molecules 2 can be easily separated from the surfaces of the fine particles and the structural substance 3, in other words, the structured area 4 can be easily disassembled. When the structured area 4 is formed and disassembled, exothermic and endothermic reactions are respectively generated between the solvent molecules 2 and the fine particle 1 and between the solvent molecules 2 and the structural substance 3 via these structural changes. Therefore, since an amount of heat corresponding to latent heat is transferred from the heat transfer surface to the heat transport medium, the heat transfer rate of a heat transport medium can be improved, and thus the heat transport capacity of the medium can increase.

(2) As fine particles 1, a material having higher heat conductivity than the heat conductivity of a solvent is used. Accordingly, since the fine particles 1 having higher heat conductivity than that of the solvent are dispersed in a heat transport medium, the heat conductivity of the heat transport medium can be accurately improved.

(3) The structural substances 3 comprise a linear chain organic material to be regularly arranged on the surface of the fine particle 1. Accordingly, structuring of the fine particles 1 and the solvent molecules 2 can be promoted.

(4) The fine particles 1 have a particle diameter D of 5 nm at the maximum. Accordingly, the surface areas of the fine particles 1 dispersed in a heat transport medium can greatly increase, and a greater amount of the solvent molecules 2 can form the structured areas 4. Therefore, the heat transport capacity of the heat transport medium can be much improved.

In addition, the heat transport medium according to the First Embodiment can be modified as follows:

### Modified Example 1

In the First Embodiment, gold (Au) is used as the fine particle 1 for the heat transport medium, water is used as the solvent, and the structural substances 3 arranged on the surface of the fine particles 1 have a hydrophilic functional group (a hydrophilic group) 3b. However, an organic solvent can be used as the solvent, as a substitute for water. More particularly, toluene, hexane, diethyl ether, chloroform, ethyl acetate, tetrahydrofuran, methylene chloride, acetone, acetonitrile, N,N-dimethylformamide, dimethyl sulfoxide, butanol acetate, 2-propanol, 1-propanol, ethanol, methanol, formic acid, and the like can be used.

In this case, as the structural substance 3, a structural substance having a group (a functional group) 3a for adsorbing on the surface of the fine particles 1 and a hydrophobic group, e.g., an alkyl group (CₙH₂ₙ₊₁) or the like can be used. The alkyl group has high affinity for the solvent molecules 2 of an organic solvent. Accordingly, the solvent molecules 2 move into the space between the structural substances 3 and are adsorbed onto the surface of the structural substance 3 so as to form a structured area 4. More particularly, for example, when toluene is used as the solvent, the diameter A of each of the solvent molecules 2 is about 0.6 nm. For example, when octadecanethiol (C₁₈H₃₇SH) is used as the structural substances 3 arranged on the surface of the fine particle 1, the length B of the structural substances 3 extending from the functional group 3a adsorbed on the fine particle 1 is about 2.5 nm. That is, in this Modified Example 1, the diameter B of the structural substance 3 is also equal to or larger than the diameter A of each of the solvent molecules 2, and the expression A≦B is satisfied. Further, the expression B≦C/2 is satisfied in this heat transport medium.

### Modified Example 2

In the First Embodiment, as illustrated in FIGS. 1(a), 1(b) and 2, the structural substances 3 arranged on the surface of the fine particle 1 consists of an organic material having a group (the functional group) 3a to be adsorbed on the surface of the fine particle 1, and a functional group 3b having high affinity for the solvent molecules 2, a main chain of which is a linear chain. However, the structural substances 3 can be changed to the following structure.

FIGS. 3(a) to 3(d) schematically illustrate only fine particles 1 and structural substances 31 to 34 in the heat transport medium illustrated in FIGS. 1(a), 1(b) and 2. In other words, the structural substance 31 may include a main chain having a linear chain structure which is arranged along the direction separating from the surface of the fine particle 1 as illustrated in FIG. 3(a). The structural substance 32 may include a main chain having a linear chain structure, which is arranged along the surface of the fine particle 1 as illustrated in FIG. 3(b). Further, the structural substance 33 may include a main chain having a cyclic structure, which is arranged along the direction separating from the surface of the fine particle 1 as illustrated in FIG. 3(c). The structural substance 34 may include a main chain having a cyclic structure which is arranged along the surface of the fine particle 1 as illustrated in FIG. 3(d).

If these structural substances 31 to 34 have structures which can be regularly arranged on the surface of the fine particle 1, they can be used for the heat transport medium. In addition, the structural substance may also have a main chain which is branched at the intermediate part along the direction separating from the surface of the fine particle.

### Modified Example 3

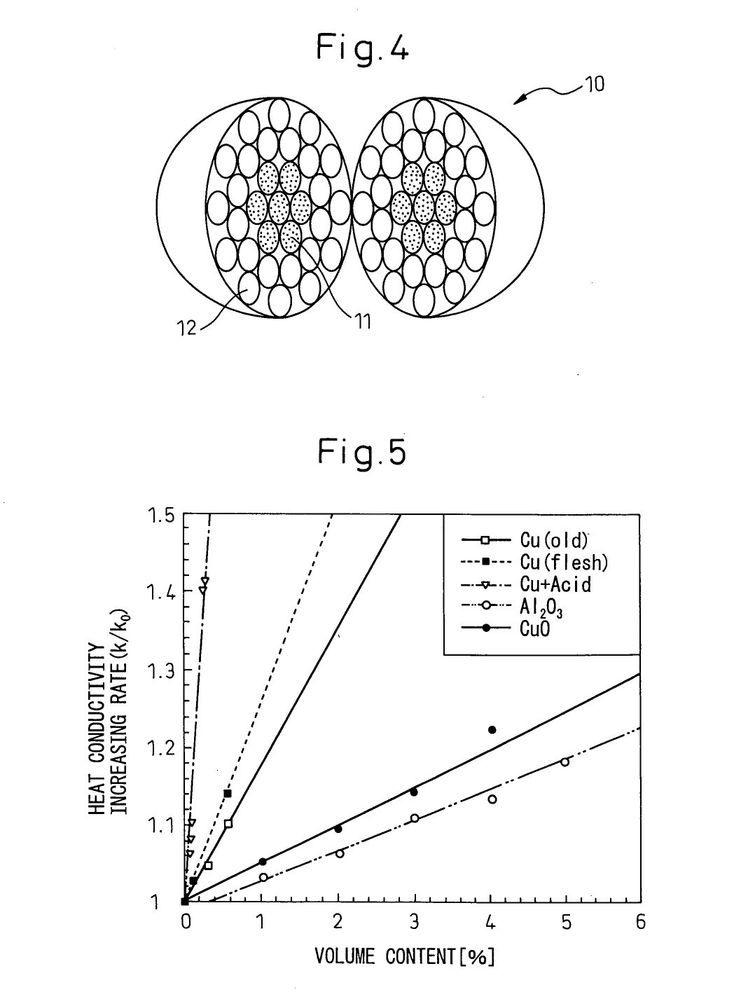

In the First Embodiment, the fine particle 1 consists of gold (Au). However, instead of this, fine particles 1 consisting of two or more kinds of materials having a layered structure as illustrated in FIG. 4 can be also used. In other words, the fine particle includes two layers of an inner layer 11 and an outer layer 12. For example, the inner layer 11 may consist of a metal having high heat conductivity, and the outer layer 12 may consist of a metal, an oxide, a resin or the like having lower heat conductivity than the metal of the inner layer 11.

Accordingly, since the material of the inner layer of the fine particle 1 has high heat conductivity, heat can be easily transferred from the heat transfer surface 5 (refer to FIG. 1 (b)) to the inside of the fine particle 1 in addition to the surface of the fine particle. In addition, when the fine particle 1 consists of three or more kinds of materials, the fine particle 1 can include a multiple layer structure corresponding to the number of the materials. Even in this case, a similar effect to that of the two layer structure can be obtained by making the material in an inner layer have higher heat conductivity.

### Second Embodiment

A heat transport medium according to the Second Embodiment will be described. The heat transport medium according to this Embodiment has a similar basic structure to that of above-described Embodiments. However, a solvent consists of two more kinds of components in this Embodiment unlike the First Embodiment. In other words, in this Embodiment, water and ethylene glycol are the solvent.

The ethylene glycol is a liquid freezing-point depressant agent having the effect to depress a freezing point, and can depress the freezing point of a solvent to about −20 degree C. In other words, ethylene glycol is more excellent in practical use in a cold environment and the like. Further, in this Embodiment, gold (Au) can also used as the fine particle 1, and mercaptosuccinic acid can be used as the structural substance 3. The heat transport medium according to this Embodiment satisfies the expression of A≦B between the length B of the structural substance 3 and the diameter A of a solvent molecule 2 having the maximum diameter among two or more kinds of the solvents, and satisfies the expression B≦C/2 between the length B of the structural substance 3 and the average clearance distance C between the fine particles 1. In addition, for example, propylene glycol, etc. other than ethylene glycol, can be used as the freezing-point depressant.

Accordingly, since any of the above-described solvent molecules 2 are easily moved into the space between the structural substances 3 arranged on the surface of the fine particle 1, and on the surface of the structural substances 3, the solvent molecules 2 are adsorbed on the surface of the fine particle 1 so as to form the structured area 4 (refer to FIGS. 1(a) and 1(b)). Further, the structural substances 3 can be easily deformed, i.e., by shacking or vibration, the adsorbed solvent molecules 2 are separated from the surface of the fine particle 1 so as to easily disassemble the structured area 4. Therefore, adsorbing/separating the solvent molecules 2 to/from the fine particle 1 can be properly controlled, and thus heat transport quantity can greatly increase.

As described above, the heat transport medium according to the Second Embodiment can obtain similar or corresponding effects to those of the above-described (1) to (4) in the First Embodiment.

In addition, in the heat transport medium according to the Second Embodiment, the kind of the solvent, structural substances 3, or constitution of the structural substances 3 can be varied, corresponding to each supplemented Modified Example of the First Embodiment.

The Second Embodiment uses two kinds of components as a solvent, and one of the components is a liquid having the effect of depressing a freezing point. However, the heat transport medium may include a solid component, and a solid freezing-point depressant as another component. For example, water may be used as a solvent, and potassium acetate, sodium acetate, or the like can be used as a freezing-point depressant.

Further, a solvent may consist of two or more kinds of components, and a solid freezing-point depressant may be included as one of the components. In this case, the freezing point of a heat transport medium can be depressed, and thus practical use of the medium in a cold environment can be increased. Further, a heat transport medium may include a rust preventing agent and an antioxidant as an additive, if necessary, in addition to a freezing-point depressant. In addition, if it is not necessary to depress the freezing point of a heat transport medium, two or more kinds of solvents not including a freezing-point depressant may be used for the heat transport medium.

### Another Embodiment

Other factors capable of modifying each Embodiment and each Modified Example described above will be described below.

In the Embodiments and Modified Examples described above, fine particles 1 having an average particle diameter D of about 1.8 nm are employed. However, if the average diameter D of fine particles 1 is about 5 nm or less, the effect of increasing the surface area of the fine particles dispersed in a solvent can be sufficiently obtained. In addition, when the heat conductivity and heat transfer rate are sufficiently improved by forming and disassembling structured areas 4 by structural substances 3 arranged on the fine particles 1 and solvent molecules 2, fine particles having an average diameter D of more than 5 nm can be used as the fine particles 1.

Further, in each Embodiment and each Modified Example, a material having higher heat conductivity than that of a solvent is employed as fine particles 1. However, when the heat conductivity and heat transfer rate are sufficiently improved by forming and disassembling structured areas 4 by structural substances 3 arranged on the fine particles 1 and solvent molecules 2, the relationship between fine particles and a solvent is not necessarily restricted to the above-described relationship.

In addition, although it is described in the above Embodiments that a solvent included in a heat transport medium consists of one or two kinds of components, a solvent can be composed of three or more kinds of components. The components in this case include water, ethylene glycol, an organic solvent (an organic material) described in Modified Example 1.

1. A heat transport medium for transporting heat transferred from a heat transfer surface, comprising a solvent and fine particles of a predetermined material, which have been dispersed in the solvent, wherein
each fine particle consists of one or more atoms, wherein a plurality of structural substances having a functional group to be adsorbed to the fine particle and protecting the fine particle are arranged on a surface of the fine particle, and
a relationship among a diameter A, a length B and an average clearance distance C satisfies the following expressions:
A≦B, and B≦C/2,
wherein the diameter A is a diameter of a solvent molecule composing the solvent, the length B is a length of the structural substance extending from the functional group adsorbed on the fine particle, and the average clearance distance C is an average clearance distance between the fine particles dispersed in the solvent.

2. The heat transport medium according to claim 1, wherein the solvent consists of a single component.

3. The heat transport medium according to claim 1, wherein the solvent consists of two or more kinds of components, and the A is a diameter of a solvent molecule having a maximum diameter among the solvent molecules.

4. The heat transport medium according to claim 1, wherein heat conductivity of the fine particle is greater than heat conductivity of the solvent.

5. The heat transport medium according to claim 1, wherein the structural substance comprises a straight-chain organic material regularly arranged on the surface of the fine particle.

6. The heat transport medium according to claim 1, wherein the structural substance comprises a cyclic organic material regularly arranged on the surface of the fine particle.

7. The heat transport medium according to claim 1, wherein an average diameter of the fine particles is 5 nm (nanometer) or less.

8. The heat transport medium according to claim 1, wherein each of the fine particles consists of a metal.

9. The heat transport medium according to claim 1, wherein each of the fine particles consists of an inorganic material.

10. The heat transport medium according to claim 1, wherein each of the fine particles consists of an oxide.

11. The heat transport medium according to claim 1, wherein each of the fine particles consists of an organic material.

12. The heat transport medium according to claim 1, wherein each of the fine particles consists of two or more kinds of materials.

13. The heat transport medium according to claim 12, wherein each of the fine particles which consists of two or more kinds of materials has a layered structure, wherein a material in an inner layer has higher heat conductivity than a material in an outer layer.

14. The heat transport medium according to claim 8, wherein each of the fine particles consists of gold, the solvent consists of water, and the structural substance has a hydrophilic group.

15. The heat transport medium according to claim 8, wherein each of the fine particles consists of gold, the solvent consists of toluene, and the structural substance has a hydrophobic group.

16. The heat transport medium according to claim 1, which further contains one or more kinds of freezing-point depressants.

17. The heat transport medium according to claim 16, wherein the freezing-point depressant is a solid freezing-point depressant.

18. The heat transport medium according to claim 16, wherein the freezing-point depressant is a liquid freezing-point depressant.

19. The heat transport medium according to claim 16, which further contains at least one of a rust preventing agent and an antioxidant as an additive.
